(19) United States
(12) Patent Application Publication
(10) Pub. No.: US 2003/0208414 A1
(43) Pub. Date: Nov. 6, 2003

(54) Systems and methods for providing item redelivery services in a delivery system

(76) Inventor: Jacquelynn Estes, Warrenton, VA (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/363,533

(22) PCT Filed: Sep. 6, 2001
(86) PCT No.: PCT/US01/27561

(51) Int. Cl. G06F 17/60

(52) U.S. Cl. 705/26

(57) ABSTRACT

A method and system for providing item redelivery services sends an item through a delivery system (130) towards a first address (150), receives an indication that the item cannot he delivered to the first address, determines an alternative address (160) utilizing a code on the item (120), and sends the item through the delivery system (130) to the alternative address (160).

### RELATED APPLICATION

Under provisions of 35 U.S.C. §119(e), the Applicant claims the benefit of U.S. provisional application No. 60/231,306, filed Sep. 8, 2000, which is incorporated herein by reference.

### TECHNICAL FIELD

The present invention relates to the field of item delivery services. More particularly, the present invention, in various specific embodiments, involves methods and systems directed to providing item redelivery when an item becomes undeliverable.

### BACKGROUND

The need to efficiently provide item redelivery services in a delivery system has become a common need for many organizations. More specifically, efficiently providing item redelivery when an item becomes undeliverable as addressed has become a critical service for many delivery system operators. This is because in an increasingly competitive environment, meeting and exceeding the expectations of those who receive a service is essential for a service provider.

One solution to the item redelivery services problem is for the delivery system operator to return an undeliverable item to the sender and allow the sender to re-label the item with an alternative recipient and resend the item through the delivery system. For example, the sender may be a mail order catalog company that sends a specified number of catalogs periodically. A certain number of the catalogs sent, however, will be undeliverable to recipients as addressed due to, for example, a recipient moving. In this case, the items undeliverable as addressed may either be disposed or may be returned to the sender. If the items are returned to the sender and the sender elects to resend the items to alternative recipients, the sender has the laborious task of receiving the items, re-labeling the items with alternative recipients and resending the items through the delivery system. The alternative recipients may be recipients that the catalog company wanted to send catalogs to, but did not due to the limited number of catalogs in the initial sending. Notwithstanding, the alternative recipients may not have been included in the initial sending of the catalog for various reasons. Accordingly, efficiently providing item redelivery services in a delivery system remains an elusive goal. Thus, there remains a need for efficiently providing item redelivery services in a delivery system. In addition, there remains a need for efficiently providing item redelivery when the item becomes undeliverable as addressed.

### SUMMARY OF THE INVENTION

In accordance with the current invention, an item redirection method and system are provided that avoid the problems associated with prior art item redirection methods and systems as discussed herein above.

In one aspect, a method for providing item delivery service consistent with the invention includes sending an item through a delivery system toward a first address, receiving an indication that the item cannot be delivered to the first address, determining if an alternative address can be obtained utilizing a code on the item, and sending the item through the delivery system to the alternative address if the alternative address can be obtained utilizing the code on the item.

In another aspect, a system for providing item delivery service comprises a delivery system configured for sending an item toward a first address, a component for detecting when the item cannot be delivered to the first address, a component for determining if an alternative address can be obtained utilizing a code on the item, and a component for sending the item through the delivery system to the alternative address if the alternative address can be obtained utilizing the code on the item.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a functional block diagram of a system for providing item redelivery services consistent with the present invention;

FIG. 2 is a flow chart of an exemplary method for providing item redelivery service consistent with the present invention;

FIG. 3 is a flow chart of a exemplary subroutine used in the exemplary method of FIG. 2 for sending an item through a delivery system toward a first address;

FIG. 4A is a flow chart of a exemplary subroutine used in the exemplary method of FIG. 2 for determining whether an alternative address can be obtained utilizing a code on an item;

FIG. 4B is a flow chart of a exemplary subroutine of an alternative embodiment of the exemplary subroutine used in FIG. 4A for determining whether an alternative address can be obtained utilizing a code on an item; and

FIG. 5 is a flow chart of a exemplary subroutine used in the exemplary method of FIG. 2 for sending an item through the delivery system to an alternative address.

### DETAILED DESCRIPTION

Reference will now be made to various embodiments according to this invention, examples of which are shown in the accompanying drawings and will be obvious from the description of the invention. In the drawings, the same reference numbers represent the same or similar elements in the different drawings whenever possible.

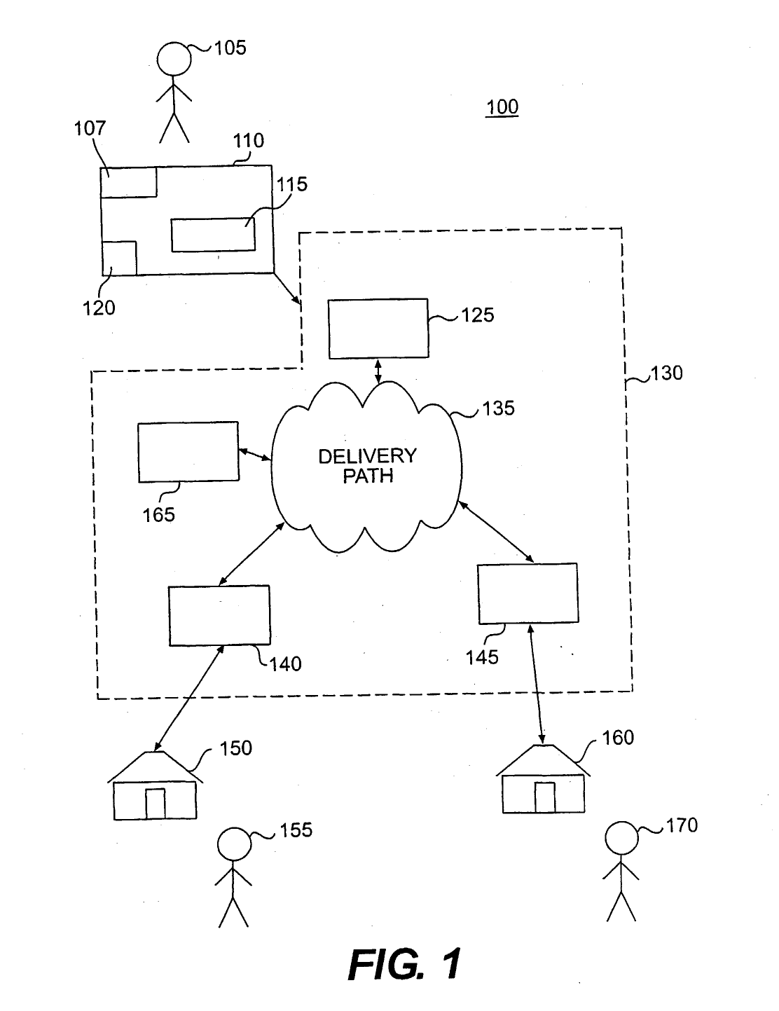

Referring to FIG. 1, an embodiment of the present invention provides an item delivery system 100. A sender 105 generates an item 110 that may be of significant value or that may have been generated at some significant cost to sender 105. If item 110 becomes undeliverable as addressed at some point as it passes through a delivery system 130, rather than disposing of item 110 as waste, sender 105 may like to have it redelivered to an alternative recipient 170 that may not have been included in an initial sending. By performing this redelivery function for sender 105, the delivery system operator could deliver item 110, avoid disposal or recycling costs, and perform this function at a lower cost than returning item 110 to sender 105 and allowing sender 105 to resend.

For example, sender 105 places item 110 into delivery system 130. Item 110 contains an address label 115 indicating a first address 150 of a recipient 155 and a return address 107 indicating where to return item 110 if necessary. Item 110 is routed through delivery system 130. Delivery system 130 comprises a sender plant 125, a delivery path 135, a first address plant 140, an alternative address plant 145, and an auxiliary processing point 165. Delivery path 135 comprises a plurality of plants similar to sender plant 125, first address plant 140 and alternative address plant 145. The plants within delivery path 135 contain, among other things, automated systems and sorting equipment and are designed to receive and process a plurality of items. Delivery system 130 is configured to sense tracking indicia placed on item 110 as it passes through the elements of delivery system 130 directing the movement of item 110 through delivery system 130.

In addition to return address 107 and address label 115, item 110 also contains a code 120 which is placed on item 110 and is used to determine if an alternative address 160 can be obtained utilizing code 120. Alternative address 160 may be obtained utilizing code 120 by correlating code 120 to alternative address 160 utilizing a list supplied by sender 105. In addition, alternative address 160 may be obtained utilizing code 120 by sending to sender 105 a reason why item 110 cannot be delivered to first address 150 and receiving instructions which may include alternative address 160 from sender 105. Those skilled in the art will appreciate that there are many other ways to obtain alternative address 160 utilizing code 120.

In the item delivery process, item 110 is sent through delivery system 130 by sender 105 to first address plant 140. At first address plant 140 or at any other plant that item 110 my pass within delivery system 130, a determination is made as to whether item 110 is deliverable to recipient 155 at address 150. If it is determined that item 110 is not deliverable to recipient 155 at address 150, code 120 from item 110 is used to determine if an alternative address 160 can be obtained utilizing code 120. If alternative address 160 can be obtained utilizing code 120 on item 110, item 110 is sent through delivery system 130 to alternative recipient 170 at alternative address 160. Payment from sender 105 may be received when the alternative address 160 is obtained or when item 110 is sent to alternative recipient 170. Those skilled in the art will appreciate that payment may be received at other points and by various means. If alternative address 160, however, cannot be obtained utilizing the code 120 on the item 110, item 110 is sent to auxiliary processing point 165 where auxiliary processing is performed. Auxiliary processing may comprise treating item 110 as waste or returning item 110 to sender 105. Those skilled in the art, however, will appreciate that may other types of auxiliary processing may be performed on item 110.

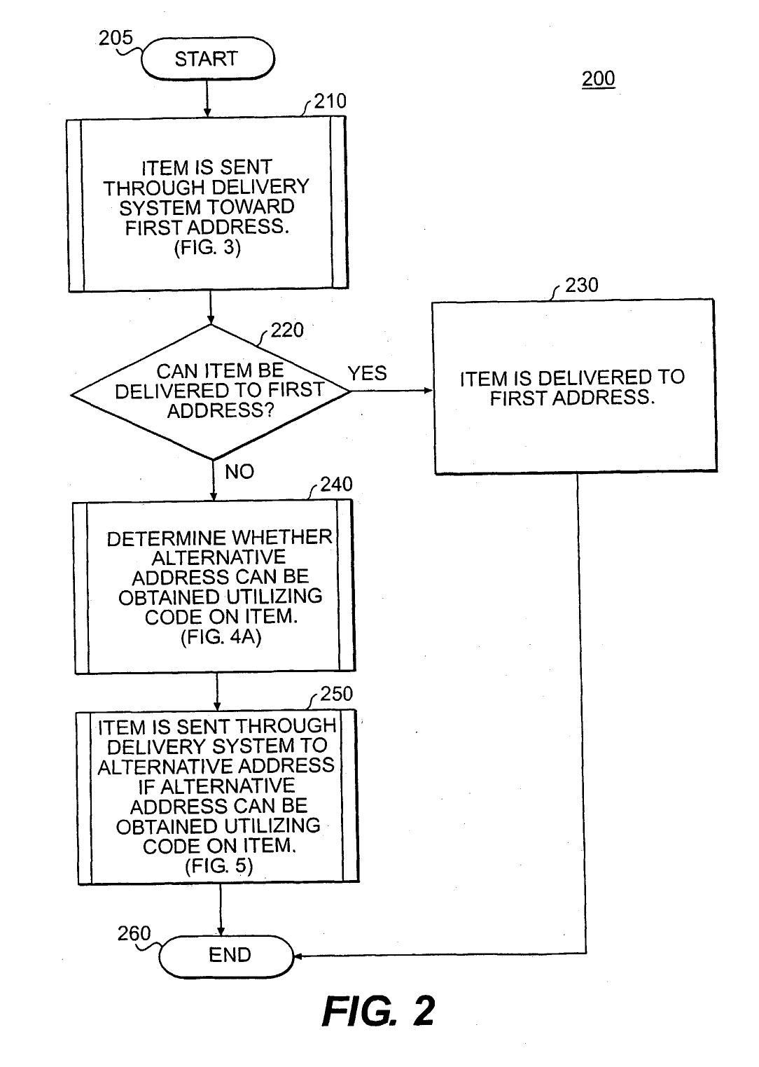

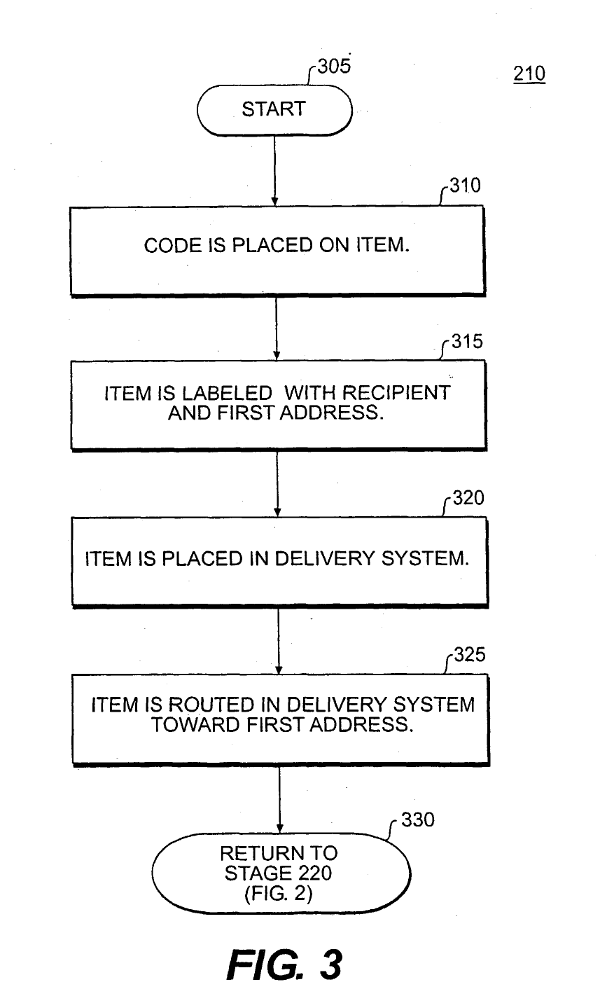

FIG. 2 is a flow chart setting forth the general stages involved in an exemplary method 200 for providing item delivery service. The implementation of the stages of exemplary method 200 in accordance with an exemplary embodiment of the present invention will be described in greater detail in FIG. 3 through FIG. 5. Exemplary method 200 begins at starting block 205 and proceeds to exemplary subroutine 210 where item 110 is sent through delivery system 130 toward first address 150. The stages of exemplary subroutine 210 are shown in FIG. 3 and will be described in greater detail below.

From exemplary subroutine 210 where item 110 is sent through delivery system 130 toward first address 150, exemplary subroutine 200 advances to decision block 220 where it is determined if item 110 can be delivered to first address 150. If item 110 can be delivered to first address 150 at decision block 220, exemplary subroutine 200 advances to stage 230 where item 110 is delivered to first address 150. In delivering item 110 to first address 150, item 110 is routed from plant to plant within delivery system 130 wherein item 110 efficiently converge on first address plant 140, which is the plant that serves the delivery address labeled on the item 110. Throughout this process, delivery system 130 tracks the progress of item 110 through delivery system 130. Once item 110 reached first address plant 140, the delivery system operator transfers item 110 from first address plant 140 to first address 150. From stage 230 where item 110 is delivered to first address 150, exemplary subroutine 200 continues to stage 260 where exemplary subroutine 200 ends.

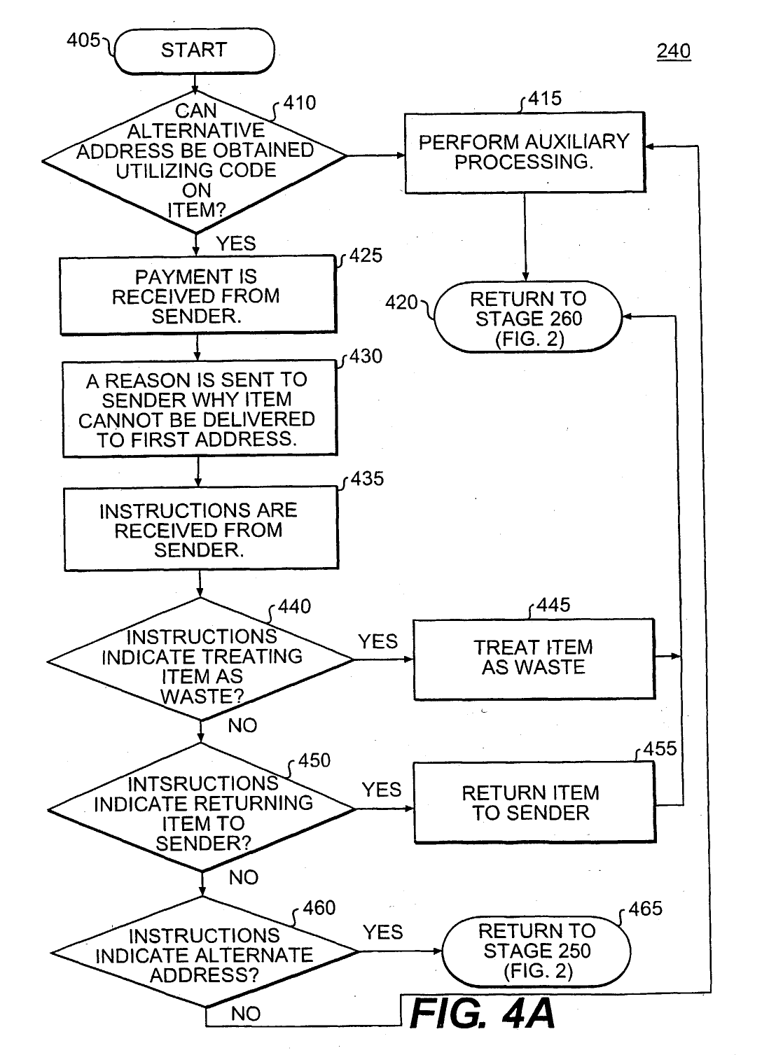

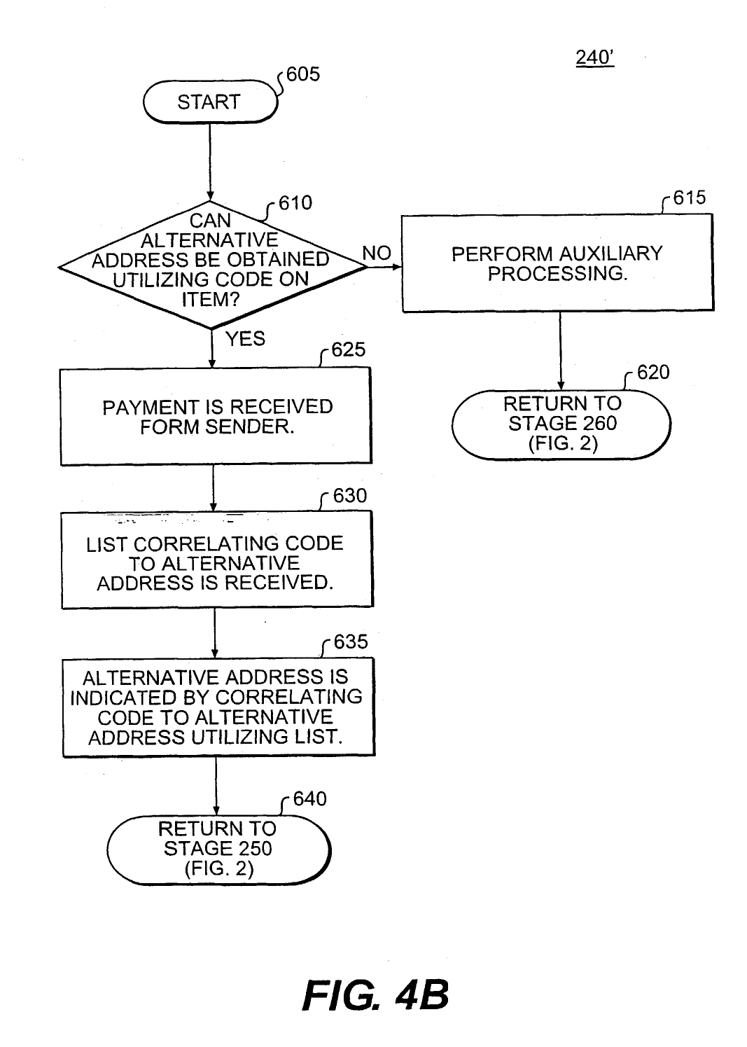

If at decision block 220 it is determined, however, that item 110 cannot be delivered to first address 150, exemplary subroutine 200 continues to exemplary subroutine 240 where a determination is made whether alternative address 160 can be obtained utilizing code 120 on item 110. Item 110 may be un-deliverable due to an incorrect, illegible, or insufficient delivery address. Those skilled in the art will appreciate, however, that many other considerations may be taken into account in determining if item 110 is deliverable. The stages of exemplary subroutine 240 are shown in FIG. 4A and will be described in greater detail below. Exemplary subroutine 240 is an alternate embodiment of exemplary subroutine 240 and will be described in greater detail below with respect to FIG. 4B.

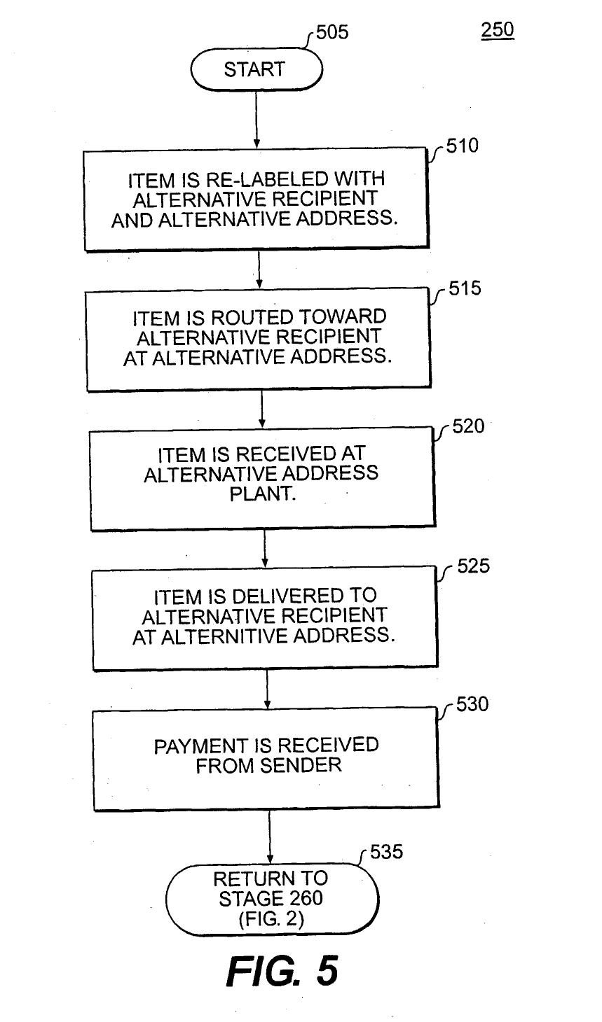

From exemplary subroutine 240, exemplary method 200 continues to exemplary subroutine 250 where item 110 is sent through delivery system 130 to alternative address 160 if alternative address 160 can be obtained utilizing code 120 on item 110. The stages of exemplary subroutine 250 are shown in FIG. 5 and will be described in greater detail below. From exemplary subroutine 250, exemplary method 200 ends at stage 260.

Item is Sent Through Delivery System Toward First Address

FIG. 3 describes the exemplary subroutine 210 from FIG. 2 in which item 110 is sent through delivery system 130 toward first address 150. Exemplary subroutine 210 begins at starting block 305 and advances to stage 310 where code 120 is placed on item 110. Code 120 is utilized by the delivery system operator to determine alternative address 160 if it becomes necessary to send item 110 to alternative address 160. Determining alternative address 160 from code 120 is discussed in greater detail with respect to FIG. 4A and FIG. 4B. In creating code 120, a bar code my be utilized. A bar code is a printed code used for recognition by a bar code scanner (reader). Traditional one-dimensional bar codes use the bars width to encode a product or account number. Two-dimensional bar codes, such as PDF417, MAXICODE and DATAMATRIX, are scanned horizontally and vertically and hold considerably more data. Generally, PDF417 is widely used for general purposes, MAXICODE is used for high-speed sorting, and DATAMATRIX is used for marking small parts. Those skilled in the art will appreciate that many other types of coding other than bar coding may be use.

After code 120 is placed on item 110 in stage 310, exemplary subroutine 210 advances to stage 315 where item 110 is labeled with recipient 155 and first address 150 which is the mail delivery address of recipient 155. This is accomplished by placing address label 115 on item 110 comprising the name of recipient 155 and first address 150.

Once item 110 is labeled with recipient 155 and first address 150 in stage 315, exemplary subroutine 210 continues to stage 320 where item 110 is placed in delivery system 130. FIG. 1 shows sender 105 placing item 110 into delivery system 130 at sender plant 125. However, item 110 may be placed in sender plant 125 or any other plant within delivery system 130. Item 110 delivered through delivery system 130 may comprise a letter or any other type mailpiece, however, those skilled in the art will appreciate that many other types of items may be delivered through delivery system 130. While FIG. 1 shows sender 105 placing item 110 into delivery system 130, this is not a requirement of this embodiment. Other persons, entities, organizations, or mechanisms may be employed to place item 110 into delivery system 130.

From stage 320 where item 110 is placed in delivery system 130, exemplary subroutine 210 advances to stage 325 where item 110 is routed in delivery system 130 toward first address 150. Delivery system 130 comprises sender plant 125, delivery path 135, first address plant 140 and alternative address plant 145. Delivery path 135 comprises a plurality of plants similar to sender plant 125, first address plant 140 and alternative address plant 145. The plants within delivery system 130 may contain, among other things, automated systems and sorting equipment located at a plurality of locations. In executing their function, the plants comprising delivery system 130 process item 110 by checking address label 115 placed on item 110. Item 110 is then routed to the next most appropriate plant in delivery system 130. The appropriateness of the next plant in delivery system 130 depends upon the present location of item 110 in delivery system 130 and where item 110 is addressed. Ultimately, item 110 is routed in delivery system 130 to the plant that serves the delivery address indicated on item 110, according to established procedures. Thus item 110 is routed from plant to plant within delivery system 130 wherein item 110 efficiently converge on first address plant 140, which is the plant that serves the delivery address labeled on the item 110. Throughout this process, delivery system 130 tracks the progress of item 110 through delivery system 130. After item 110 is routed in delivery system 130 toward first address 150 in stage 325, exemplary subroutine 210 advances to stage 330 and returns to decision block 220 of FIG. 2.

Determine Whether Alternative Address Can be Obtained Utilizing Code on Item

FIG. 4A describes the exemplary subroutine 240 from FIG. 2 in which a determination is made whether alternative address 160 can be obtained utilizing code 120 on item 110. Exemplary subroutine 240 begins at starting block 405 and advances to decision block 410 where it is determined if alternative address 160 can be obtained utilizing code 120 on item 110. If alternative address 160 cannot be obtained utilizing code 120 on item 110 at decision block 410, exemplary subroutine 240 advances to stage 415 where auxiliary processing is performed at auxiliary processing point 165. Auxiliary processing may comprise address correction service (re-label with a correct address) or return service (return item to the sender) may be performed. In this case, an operator specialized in the handling of such items is required. If item 110 requires return service, return address 107 on item 110 is read and item 110 is sent to return address 107 accordingly. Return address 107 is an element of item 110 that is usually placed in the upper left corner of item 110 to indicate the address of sender 105. This address indicates where sender 105 wants item 110 returned if it is undeliverable. In addition return address 107 may indicate where sender 105 will receive a bill for any fees due for the return of item 110. If item 110 requires address correction service, the operator obtains the proper address of recipient 155 or the reason for non-delivery. While auxiliary processing may comprise address correction service or return service, those skilled in the art will appreciate that may other types of auxiliary processing may be performed. From stage 415 where auxiliary processing is performed, exemplary subroutine 240 continues to stage 420 and returns to stage 260 of FIG. 2.

If at decision block 410 it is determined, however, that alternative address 160 can be obtained utilizing code 120 on item 110, exemplary subroutine 240 continues to stage 425 where payment is received from sender 105. The payment may be received by billing sender 105, debiting sender's checking account, or debiting sender's credit card account. Those skilled in the art, however, will appreciate that many other procedures may be employed in receiving the payment from sender 105.

After payment is received from sender 105 in stage 425, exemplary subroutine 240 advances to stage 430 where a reason is sent to sender 105 why item 110 cannot be delivered to first address 150, sender 105 indicated by code 120. The reason why item 110 cannot be delivered to first address 150 may be sent to sender 105 using, for example, regular mail, e-mail, voice mail, facsimile, the internet, or an interactive voice response system. An interactive voice response system (IVR) is an automated telephone answering system that responds with a voice menu and allows the delivery system operator to make choices and enter information via the telephone keypad. IVR systems are widely used in call centers as well as a replacement for human switchboard operators. Database access and fax response may also be implemented in delivery instructions submission. Those skilled in the art, however, will appreciate that many other ways exist for sending the reason why item 110 cannot be delivered to first address 150 to sender 105.

Once a reason is sent to sender 105 why item 110 cannot be delivered to first address 150 in stage 430, exemplary subroutine 240 continues to stage 435 where instructions are received from sender 105. Similar to sending the reason why item 110 cannot be delivered to first address 150 to sender 105, instructions may be received from sender 105 by using, for example, regular mail, e-mail, voice mail, facsimile, the internet, or an interactive voice response system. Those skilled in the art, however, will appreciate that many other ways exist for receiving instructions from sender 105.

From stage 435 where instructions are received from sender 105, exemplary subroutine 240 advances to decision block 440 where it is determined if instructions call for treating item 110 as waste. If instructions call for treating item 110 as waste at decision block 440, exemplary subroutine 240 advances to stage 445 where item 110 is treated as waste. From stage 445 where item 110 is treated as waste, exemplary subroutine 240 continues to stage 420 and returns to stage 260 of FIG. 2. If at decision block 440 it is determined, however, that instructions do not call for treating item 110 as waste, exemplary subroutine 240 continues to decision block 450 where it is determined if instructions call for returning item 110 to sender 105. If instructions call for returning item 110 to sender 105 at decision block 450, exemplary subroutine 240 advances to stage 455 where item 110 is returned to sender 105. In returning item 110 to sender 105, an operator specialized in the handling of such items may be required. If item 110 requires return service, return address 107 on item 110 may be read and item 110 is sent to return address 107 accordingly. Return address 107 is an element of item 110 that is usually placed in the upper left corner of item 110 to indicate the address of sender 105. Alternatively, the instructions from sender 105 may include a return address. This address indicates where sender 105 wants item 110 returned if it is undeliverable. In addition return address 107 may indicate where sender 105 will receive a bill for any fees due for the return of item 110. From stage 455 where item 110 is returned to sender 105, exemplary subroutine 240 continues to stage 420 and returns to stage 260 of FIG. 2.

If at decision block 450 it is determined, however, that instructions do not indicate returning item 110 to sender 105, exemplary subroutine 240 continues to decision block 460 where it is determined if instructions indicate alternative address 160. If instructions do not indicate alternative address 160 at decision block 460, exemplary subroutine 240 advances to stage 415 where auxiliary processing is performed at auxiliary processing point 165. Auxiliary processing is discussed above with respect to stage 415. From stage 415 where auxiliary processing is performed, exemplary subroutine 240 continues to stage 420 and returns to stage 260 of FIG. 2. If at decision block 460 it is determined, however, that instructions indicate alternative address 160, exemplary subroutine 240 continues to stage 465 and returns to stage 250 of FIG. 2.

Item is Sent Through Delivery System to Alternative Address

FIG. 5 describes the exemplary subroutine 250 from FIG. 2 in which item 110 is sent through delivery system 130 to alternative address 160. Exemplary subroutine 250 begins at starting block 505 and advances to stage 510 where item 110 is re-labeled with alternative recipient 170 and alternative address 160. This is accomplished by replacing address label 115 on item 110 with an alternative address label comprising the name of alternative recipient 170 and alternative address 160.

After item 110 is re-labeled with alternative recipient 170 and alternative address 160 in stage 510, exemplary subroutine 250 advances to stage 515 where item 110 is routed toward alternative recipient 170 at alternative address 160. This routing comprises routing item 110 from plant to plant within delivery system 130 wherein item 110 efficiently converges on alternative address plant 145. Alternative address plant 145 is the plant within delivery system 130 that serves alternative address 160. Throughout this process, delivery system 130 may track the progress of item 110 through delivery system 130.

Once item 110 is routed toward alternative recipient 170 at alternative address 160 in stage 515, exemplary subroutine 250 continues to stage 520 where item 110 is received at alternative address plant 145. From stage 520 where item 110 is received at alternative address plant 145, exemplary subroutine 250 advances to stage 525 where item 110 is delivered to alternative recipient 170 at alternative address 160. After item 110 is delivered to alternative recipient 170 at alternative address 160 in stage 525, exemplary subroutine 250 advances to stage 530 where payment is received from sender 105. The payment may be received by billing sender 105, debiting sender's checking account, or debiting sender's credit card account. Those skilled in the art, however, will appreciate that many other procedures may be employed in receiving the payment from sender 105. Once payment is received from sender 105 in stage 530, exemplary subroutine 250 continues to stage 535 and returns to stage 260 of FIG. 2.

Alternative Embodiment of Determining Alternative Address

FIG. 4B describes the exemplary subroutine 240 which is an alternative embodiment of exemplary subroutine 240 from FIG. 2 in which a determination is made whether alternative address 160 can be obtained utilizing code 120 on item 110. Exemplary subroutine 240 begins at starting block 605 and advances to decision block 610 where it is determined if alternative address 160 can be obtained utilizing code 120 on item 110. If alternative address 160 cannot be obtained utilizing code 120 on item 110 at decision block 610, exemplary subroutine 240 advances to stage 615 where auxiliary processing is performed at auxiliary procession point 165. Auxiliary processing may comprise address correction service (re-label with a correct address) or return service (return item to the sender) may be performed. In this case, an operator specialized in the handling of such items is required. If item 110 requires return service, return address 107 on item 110 is read and item 110 is sent to return address 107 accordingly. Return address 107 is an element of item 110 that is usually placed in the upper left corner of item 110 to indicate the address of sender 105. This address indicates where sender 105 wants item 110 returned if it is undeliverable. In addition return address 107 may indicate where sender 105 will receive a bill for any fees due for the return of item 110.

When item 110 requires address correction service, the operator obtains the proper address of recipient 155 or the reason for non-delivery. While auxiliary processing may comprise address correction service or return service, those skilled in the art will appreciate that may other types of auxiliary processing may be performed. From stage 615 where auxiliary processing is performed, exemplary subroutine 240 continues to stage 620 and returns to stage 260 of FIG. 2.

If at decision block 610 it is determined, however, that alternative address 160 can be obtained utilizing code 120 on item 110, exemplary subroutine 240 continues to stage 625 where payment is received from sender 105. The payment may be received by billing sender 105, debiting sender's checking account, or debiting sender's credit card account. Those skilled in the art, however, will appreciate that many other procedures may be employed in receiving the payment from sender 105.

After payment is received from sender 105 in stage 625, exemplary subroutine 240 advances to stage 630 where a list correlating code 120 to alternative address 160 is received. The list correlating code 120 to alternative address 160 may be received from sender 105 using, for example, regular mail, e-mail, voice mail, facsimile, the internet, or an interactive voice response system. Database access and fax response may also be implemented in delivery instructions submission. Those skilled in the art, however, will appreciate that many other ways exist for receiving the list correlating code 120 to alternative address 160 from sender 105.

Once the list correlating code 120 to alternative address 160 is received in stage 630, exemplary subroutine 240 continues to stage 635 where alternative address 160 is indicated by correlating code 120 to alternative address 160 utilizing the list. After alternative address 160 is indicated by correlating code 120 to alternative address 160 utilizing the list in stage 635, exemplary subroutine 240 continues to stage 640 and returns to stage 250 of FIG. 2.

In view of the foregoing, it will be appreciated that the present invention provides a system and method for providing item redelivery services in a delivery system. Still, it should be understood that the foregoing relates only to the exemplary embodiments of the present invention, and that numerous changes may be made thereto without departing from the spirit and scope of the invention as defined by the following claims.

We claim:

1. A method for providing item delivery service, comprising:
sending an item through a delivery system toward a first address;
receiving an indication that the item cannot be delivered to the first address;
determining an alternative address utilizing a code on the item; and
sending the item through the delivery system to the alternative address.

2. The method of claim 1, wherein the determining stage further comprises indicating the alternative address by correlating the code to the alternative address utilizing a list supplied by a sender.

3. The method of claim 1, wherein the determining stage further comprises:
sending to a sender a reason why the item cannot be delivered to the first address, the sender indicated by the code; and
receiving instructions from the sender.

4. The method of claim 3, wherein the receiving instructions from the sender stage further comprises receiving instructions comprising at least one of the following: treating the item as waste, returning the item to the sender, and receiving an indication of the alternative address.

5. The method of claim 3, wherein the sending to a sender a reason why the item cannot be delivered to the first address stage is performed using at least one of the following media: regular mail, e-mail, facsimile, internet, and an interactive voice response system.

6. The method of claim 3, wherein the receiving stage is performed using at least one of the following media: regular mail, e-mail, facsimile, internet, and an interactive voice response system.

7. The method of claim 1 further comprising providing auxiliary processing if the alternative address cannot be obtained utilizing the code on the item within a specified period of time.

8. The method of claim 7, wherein the providing auxiliary processing stage comprises at least on of the following: treating the item as waste and returning the item to a sender.

9. The method of claim 1 further comprising processing mailpieces addressed to the recipient at the first address.

10. The method of claim 1 further comprising receiving payment from a sender if the alternative address can be obtained utilizing the code on the item, the payment received by at least one of the following: billing the sender, debiting sender's checking account, and debiting sender's credit card account.

11. The method of claim 1 further comprising receiving payment from a sender if the item is sent through the delivery system to the alternative address, the payment received by at least one of the following: billing the sender, debiting sender's checking account, and debiting sender's credit card account.

12. A system for providing item delivery service, comprising:
a delivery system configured for sending an item toward a first address;
a component for detecting when the item cannot be delivered to the first address;
a component for determining an alternative address utilizing a code on the item; and
a component for sending the item through the delivery system to the alternative address.

13. The system of claim 12, wherein the component for determining comprises a component for indicating the alternative address by correlating the code to the alternative address utilizing a list supplied by a sender.

14. The system of claim 12, wherein the component for determining comprises:
a component for sending to a sender indicated by the code a reason why the item cannot be delivered to the first address; and
a component for receiving instructions from the sender.

15. The system of claim 14, wherein the instructions comprises at least one of the following: an indication to treating the item as waste, an indication to return the item to the sender, and an indication of the alternative address.

16 The system of claim 14, wherein the component for sending to a sender indicated by the code a reason why the item cannot be delivered to the first address utilizes at least one of the following media: regular mail, e-mail, facsimile, internet, and an interactive voice response system.

17. The system of claim 14, wherein the component for receiving utilizes at least one of the following media: regular mail, e-mail, facsimile, internet, and an interactive voice response system.

18. The system of claim 12 further comprising a component for providing auxiliary processing if the alternative address cannot be obtained utilizing the code on the item within a specified period of time.

19. The system of claim 18, wherein the component for auxiliary processing comprises a component for at least one of the following: treating the item as waste and returning the item to a sender.

20. The system of claim 12, wherein the item comprises a mailpiece.

21. The system of claim 12 further comprising a component for receiving payment from a sender if the alternative address can be obtained utilizing the code on the item, the payment received by at least one of the following: billing the sender, debiting sender's checking account, and debiting sender's credit card account.

22. The system of claim 12 further comprising a component for receiving payment from a sender if the item is sent through the delivery system to the alternative address, the payment received by at least one of the following: billing the sender, debiting sender's checking account, and debiting sender's credit card account.

23. A method for providing item delivery service, comprising:
sending an item through a delivery system toward a first address;
receiving an indication that the item cannot be delivered to the first address;
determining an alternative address utilizing a code on the item, comprising:
sending over a first communications channel to a sender a reason why the item cannot be delivered to the first address, the sender indicated by the code, the media comprising at least one of the following: regular mail, e-mail, facsimile, internet, and an interactive voice response system, and
receiving over a second communications channel instructions from the sender, the instructions comprising at least on of the following: an indication to treating the item as waste, an indication to return the item to the sender, and an indication of the alternative address, the media comprising at least one of the following:
regular mail, e-mail, facsimile, internet, and an interactive voice response system;
sending the item through the delivery system to the alternative address;
providing auxiliary processing if the alternative address cannot be obtained utilizing the code on the item within a specified period of time, wherein providing auxiliary processing comprises at least on of the following: treating the item as waste and returning the item to a sender;
receiving payment from the sender if the alternative address can be obtained utilizing the code on the item, the payment received by at least one of the following: billing the sender, debiting senders checking account, and debiting senders credit card account; and
receiving payment from the sender if the item is sent through the delivery system to the alternative address, the payment received by at least one of the following: billing the sender, debiting senders checking account, and debiting sender's credit card account.
